(19) United States
(12) Patent Application Publication
(10) Pub. No.: US 2026/0297293 A1
(43) Pub. Date: Oct. 1, 2026

(54) TITANIUM OXIDE PARTICLES, RESIN COMPOSITION FOR ELECTRONIC MATERIALS, MOLDED ARTICLE, COMPONENT FOR ELECTRONIC DEVICES, AND METHOD FOR PRODUCING TITANIUM OXIDE PARTICLES

(71) Applicant: DIC Corporation, Tokyo (JP)

(72) Inventors: Shaowei Yang, Qingdao, Shandong (CN); Ryuichi Kiyooka, Chiba (JP); Takami Arakawa, Chiba (JP); Koji Omichi, Chiba (JP); Jianjun Yuan, Chiba (JP); Yuanquan Feng, Qingdao, Shandong (CN); Wei Zhao, Qingdao, Shandong (CN)

(73) Assignee: DIC Corporation, Tokyo (JP)

(21) Appl. No.: 19/479,512

(22) PCT Filed: Apr. 30, 2024
(86) PCT No.: PCT/CN2024/090741

§ 371 Date: Oct. 28, 2025

(30) Foreign Application Priority Data
May 17, 2023 (WO) PCT/CN2023/094777

(51) Int. Cl. C08K 3/22; C01G 23/08

(52) U.S. Cl. CPC C08K 3/22; C01G 23/08; C01P 2002/54; C01P 2002/60; C01P 2002/72; C01P 2004/03; C01P 2004/61; C01P 2004/62; C08K 2003/2241; C08K 2201/005

(57) ABSTRACT

Titanium oxide particles having a low dielectric loss tangent value are provided. Titanium oxide particles contain titanium dioxide, and the titanium dioxide has an average crystallite size of greater than or equal to 220 nm as determined by a peak at 2θ=27.5°±1.0° obtained in an X-ray diffraction measurement. A method for producing the titanium oxide particles includes a mixing step and a firing step. The mixing step is a step of mixing a titanium compound with a molybdenum compound and at least one of a potassium compound or a sodium compound to form a mixture. The firing step is a step of firing the mixture. A molar ratio of Mo to M1 of the mixture is more than 0.5, where M1 represents Na and K.

### TECHNICAL FIELD

The present invention relates to titanium oxide particles, to a resin composition for electronic materials, to a molded article, to a component for electronic devices, and to a method for producing titanium oxide particles.

### BACKGROUND ART

Titanium oxide particles are used in a wide range of fields, such as inks, resin fillers, catalysts, catalyst supports, adsorbents, photocatalysts, antimicrobial agents, optical materials, cosmetic additives, pigments, coating compositions, fillers, and electronics materials. Patent Literature 1 discloses molybdenum-containing rutile-type titanium oxide particles, and the titanium oxide particles have an average particle size of 0.1 to 100 μm.

### CITATION LIST

### Patent Literature

[PTL 1]

Japanese Unexamined Patent Application Publication No. 2016-13954

### SUMMARY OF INVENTION

### Technical Problem

However, in instances where titanium oxide particles are to be used in a manner that takes advantage of their dielectric properties, there is still room for improvement in terms of reducing a dielectric loss tangent of the titanium oxide particles.

The present invention has been made to solve the problem described above, and an object of the present invention is to provide titanium oxide particles having a low dielectric loss tangent.

### Solution to Problem

(1) Titanium oxide particles containing titanium dioxide, wherein the titanium dioxide has an average crystallite size of greater than or equal to 220 nm as determined by a peak at 2θ=27.5°±1.0° obtained in an X-ray diffraction measurement.

(2) The titanium oxide particles according to (1), wherein the titanium oxide particles have an average particle size of 0.1 to 300 μm.

(3) The titanium oxide particles according to (1) or (2), wherein the titanium oxide particles contain molybdenum.

(4) The titanium oxide particles according to any one of (1) to (3), wherein the titanium dioxide includes rutile-type titanium dioxide.

(5) The titanium oxide particles according to any one of (1) to (4), wherein the titanium oxide particles have a dielectric loss tangent at 1 GHz of less than or equal to 0.0040.

(6) The titanium oxide particles according to any one of (1) to (5), wherein the titanium oxide particles are intended for use in an electronic material.

(7) A resin composition for an electronic material, the resin composition including a resin and the titanium oxide particles according to any one of (1) to (6).

(8) A molded article of the resin composition for an electronic material according to (7).

(9) A component for an electronic device, the component including the titanium oxide particles according to any one of (1) to (6).

(10) A method for producing the titanium oxide particles according to any one of (1) to (6) including a mixing step of mixing a titanium compound with a molybdenum compound and at least one of a potassium compound or a sodium compound to form a mixture; and a firing step of firing the mixture, wherein a molar ratio of Mo to M1 of the mixture is more than 0.5, where M1 represents Na and K.

(11) The method according to (10) for producing the titanium oxide particles, wherein the mixing step is a step of mixing a titanium compound with a compound containing molybdenum and potassium or with a compound containing molybdenum and sodium to form a mixture, the compound containing molybdenum and potassium is K₂Mo₂O₇, and the compound containing molybdenum and sodium is Na₂Mo₂O₇.

(12) The method according to (10) or (11) for producing the titanium oxide particles, wherein, in the firing step, the mixture is fired under conditions including a firing temperature of 1200 to 1350° C. and a holding time associated with the firing temperature of 15 minutes to 30 hours.

### Advantageous Effects of Invention

The present invention can provide titanium oxide particles having a low dielectric loss tangent.

### BRIEF DESCRIPTION OF DRAWINGS

FIG. 1 is an SEM image of titanium oxide particles of Example 1.

FIG. 2 is an SEM image of titanium oxide particles of Example 2.

FIG. 3 is an SEM image of titanium oxide particles of Example 3.

FIG. 4 is an SEM image of titanium oxide particles of Example 4.

FIG. 5 is an SEM image of titanium oxide particles of Example 5.

FIG. 6 is an SEM image of titanium oxide particles of reference example 1.

FIG. 7 is an SEM image of titanium oxide particles of reference example 2.

FIG. 8 is an SEM image of titanium oxide particles of reference example 3.

FIG. 9 is an X-ray diffraction (XRD) pattern of the titanium oxide particles of Example 1.

### DESCRIPTION OF EMBODIMENTS

Embodiments of titanium oxide particles, a resin composition for electronic materials, a molded article, a component for electronic devices, and a method for producing titanium oxide particles, according to the present invention, will be described below.

### [Titanium Oxide Particles]

According to an embodiment, titanium oxide particles contain titanium dioxide, and the titanium dioxide has an average crystallite size of greater than or equal to 220 nm as determined by a peak at 2θ=27.5°±1.0° obtained in an X-ray diffraction measurement.

The average crystallite size of the titanium dioxide present in the titanium oxide particles as determined by a peak at 2θ=27.5°±1.0° obtained in an X-ray diffraction measurement is greater than or equal to 220 nm. The average crystallite size is preferably greater than or equal to 250 nm, more preferably greater than or equal to 300 nm, even more preferably greater than or equal to 350 nm, still more preferably greater than or equal to 400 nm, and particularly preferably greater than or equal to 500 nm. The presence of titanium dioxide having an average crystallite size greater than or equal to the lower limit reduces the value of a dielectric loss tangent of the titanium oxide particles.

The average crystallite size of the titanium dioxide as determined by a peak at 2θ=27.5°±1.0° obtained in an X-ray diffraction measurement may have an upper limit, which may be, for example, less than or equal to 1000 nm, less than or equal to 800 nm, less than or equal to 700 nm, less than or equal to 650 nm, or less than or equal to 600 nm.

The values of the average crystallite size of the titanium dioxide as determined by a peak at 2θ=27.5°±1.0° obtained in an X-ray diffraction measurement may have a numerical range, which may be, for example, 220 nm or greater and 1000 nm or less, 250 nm or greater and 1000 nm or less, 300 nm or greater and 800 nm or less, 350 nm or greater and 700 nm or less, 400 nm or greater and 650 nm or less, or 500 nm or greater and 600 nm or less.

The average crystallite size of the titanium oxide particles of this embodiment can be determined with the following measurement method.

### [Measurement of Crystallite Size]

The measurement is performed as follows. An X-ray diffractometer (e.g., SmartLab, manufactured by Rigaku Corporation) is used. An ultrahigh-resolution spiral analyzer (CALSA) is used as a detector, and PDXL2 is used as analysis software. The measurement mode to be used is the 2θ/θ mode, and the measurement conditions are as described below. From the full width at half maximum of a peak appearing at 2θ=27.5°±1.0°, the average crystallite size of the titanium dioxide is calculated using the Scherrer equation.

### [Measurement Conditions]

Scanning range: 2θ=10 to 70°
Step: 2θ=0.002°
Speed: 2θ=0.05°/minute
βs=20 rpm
Soller/PSC: 2θ=2.5° short
Soller: 2θ=2.5° Analysis software: PDXL2
System-specific half width: none
Peak shape: automated analysis with a CALSA function

The titanium oxide particles of this embodiment contain titanium dioxide (TiO₂). Preferably, the titanium dioxide (TiO₂) is present in the titanium oxide particles of this embodiment in an amount greater than or equal to 50 mass % based on a total mass (100 mass %) of the titanium oxide particles. The titanium dioxide is present preferably in an amount of 50 to 99.9 mass %, more preferably 80 to 99.9 mass %, and even more preferably 90 to 99.8%.

A content of the titanium dioxide (TiO₂) in the titanium oxide particles of this embodiment may be a value calculated by XRF analysis as described below.

In the titanium oxide particles of this embodiment, a titanium content, in terms of a content percentage calculated as a TiO₂ content percentage, may be greater than or equal to 50 mass % or may be 50 to 99.9 mass %, 80 to 99.9 mass %, or 90 to 99.8 mass %, as determined by an XRF analysis of the titanium oxide particles, the content percentage being based on the total mass of the titanium oxide particles.

The “content percentage calculated as a TiO₂ content percentage” is a value determined from an amount of TiO₂. The amount of TiO₂ is calculated from a titanium content determined by an XRF analysis of the titanium oxide particles, with the calculation being performed using a TiO₂ calculation standard curve.

The titanium oxide particles of this embodiment may contain molybdenum. The titanium oxide particles of this embodiment may contain molybdenum derived from a molybdenum compound that may be used in a production method described later.

Regarding the molybdenum that may be present in the titanium oxide particles of this embodiment, a state of existence and an amount of the molybdenum are not particularly limited. Examples of the molybdenum that may be present in the titanium oxide particles include molybdenum metal, molybdenum oxide, and partially reduced molybdenum compounds. It can be assumed that the molybdenum can be present as MoO₃ in the titanium oxide particles. In addition to MoO₃, one or more other types of molybdenum, such as MoO₂ and Moo, may be present in the titanium oxide particles.

The form in which the molybdenum is present is not particularly limited, and any of the following forms are possible: a form in which molybdenum adheres to a surface of the titanium oxide particles; a form in which molybdenum replaces a portion of the crystal structure of the titanium oxide particles; an amorphous form; and a combination of any of these forms.

In the titanium oxide particles of this embodiment, a molybdenum content, in terms of a content percentage calculated as a MoO₃ content percentage, may be greater than or equal to 0.01 mass % or may be 0.01 to 25 mass %, 0.05 to 10 mass %, or 0.1 to 5 mass %, as determined by an XRF analysis of the titanium oxide particles, the content percentage being based on the total mass of the titanium oxide particles.

The “content percentage calculated as a MoO₃ content percentage” is a value determined from an amount of MoO₃. The amount of MoO₃ is calculated from a molybdenum content determined by an XRF analysis of the titanium oxide particles, with the calculation being performed using a MoO₃ calculation standard curve.

The titanium oxide particles of this embodiment may contain at least one of potassium or sodium. The titanium oxide particles of this embodiment may contain at least one of potassium or sodium derived from at least one of a potassium compound or a sodium compound that may be used in the production method described later.

In the titanium oxide particles, a potassium and/or sodium content, in terms of a total content percentage calculated as the sum of K₂O and Na₂O content percentages, may be less than or equal to 5 mass % or 0.01 to 5 mass %, as determined by an XRF analysis of the titanium oxide particles, the total content percentage being based on the total mass of the titanium oxide particles.

The “total content percentage calculated as the sum of K₂O and Na₂O content percentages” is a value determined from the sum of an amount of K₂O and an amount of Na₂O. The amount of K₂O is calculated from a potassium content determined by an XRF analysis of the titanium oxide particles, with the calculation being performed using a K₂O calculation standard curve. The amount of Na₂O is calculated from a sodium content determined by the XRF analysis, with the calculation being performed using a Na₂O calculation standard curve. Note that the potassium content and/or the sodium content in the titanium oxide particles may be 0.

Regarding the titanium content, the molybdenum content, and the potassium and/or sodium content of the titanium oxide particles, the values of the contents may be selected in a desired combination.

An example of the titanium oxide particles of this embodiment is titanium oxide particles in which the titanium content percentage calculated as a TiO₂ content percentage is 50 to 99.9 mass %, and the molybdenum content percentage calculated as a MoO₃ content percentage is 0.01 to 25 mass %, as determined by an XRF analysis of the titanium oxide particles, the content percentages being based on the total mass of the titanium oxide particles.

Another example of the titanium oxide particles of this embodiment is titanium oxide particles in which the titanium content percentage calculated as a TiO₂ content percentage is 50 to 99.9 mass %, the molybdenum content percentage calculated as a MoO₃ content percentage is 0.01 to 25 mass %, and the potassium and/or sodium total content percentage calculated as the sum of K₂O and Na₂O content percentages is 0.01 to 5 mass %, as determined by an XRF analysis of the titanium oxide particles, the content percentages being based on the total mass of the titanium oxide particles.

The titanium oxide particles of this embodiment may have an average particle size of greater than or equal to 0.1 μm, greater than or equal to 0.5 μm, greater than or equal to 5 μm, or greater than or equal to 50 μm. Titanium oxide particles having an average particle size greater than or equal to the lower limit provide ease of handling and exhibit an excellent resin-filling property, which enables the titanium oxide particles to easily fill a resin composition at a high density, in instances in which the titanium oxide particles are included in a resin composition.

The average particle size of the titanium oxide particles may be less than or equal to 300 μm, less than or equal to 250 μm, less than or equal to 2θ0 μm, or less than or equal to 150 μm. Titanium oxide particles having an average particle size less than or equal to the upper limit facilitate the production of a molded article having excellent surface smoothness.

The values of the average particle size of the titanium oxide particles may have a numerical range, which may be, for example, 0.1 μm or greater and 300 μm or less, 0.5 μm or greater and 250 μm or less, 5 μm or greater and 2θ0 μm or less, or 50 μm or greater and 150 μm or less.

In this specification, the average particle size of the titanium oxide particles is an average particle size determined as follows. An image of the titanium oxide particles is acquired with a scanning electron microscope (SEM), 50 or more titanium oxide particles are randomly selected from the titanium oxide particles observed in the two-dimensional image, a maximum length among distances between two points on a contour of a primary particle of each of the 50 or more particles is determined as a particle size, and an average of the particle sizes is employed.

In the titanium oxide particles, regarding the particle size of the titanium oxide particles measured as described above, a value calculated as a standard deviation/the average particle size×100 is preferably less than or equal to 30% or is preferably 2 to 30%, more preferably 5 to 25%, and even more preferably 10 to 25%. Titanium oxide particles having a value of the standard deviation/the average particle size×100 within any of the above-mentioned numerical ranges exhibit an enhanced resin-filling property in instances in which the titanium oxide particles are included in a resin composition.

The titanium oxide particles of this embodiment may have a median diameter D₅₀ of 0.1 μm or greater and 300 μm or less, 0.5 μm or greater and 2θ0 μm or less, or 50 μm or greater and 150 μm or less.

The median diameter D₅₀ of the titanium oxide particles of this embodiment can be determined as follows. A particle size distribution of a sample powder is measured in a dry state with a dry laser-diffraction particle size distribution analyzer (e.g., HELOS (H3355) & RODOS, manufactured by Japan Laser Corporation) under conditions including a dispersion pressure of 3 bar and a suction pressure of 90 mbar, and a particle diameter at a point at which the distribution curve of a cumulative volume percentage intersects a horizontal axis at 50% is designated as the D₅₀.

Regarding the titanium dioxide present in the titanium oxide particles of this embodiment, its crystal structure can be determined from an XRD pattern of a spectrum obtained in an XRD analysis.

Titanium dioxide can have anatase-type, rutile-type, and brookite-type crystal structures. In the titanium oxide particles of this embodiment, it is preferable that the titanium dioxide include rutile-type titanium dioxide. It is preferable that the titanium dioxide have a degree of rutile crystallinity of greater than or equal to 90%. Titanium oxide particles containing rutile-type titanium dioxide have a higher relative dielectric constant than titanium oxide particles containing titanium dioxide having a different crystal structure and, therefore, can facilitate miniaturization of substrates for millimeter wave (e.g., a wavelength of 4 to 12 mm and a frequency of 24 to 71 GHz) antennas for the 5th generation mobile networks (5G).

The later-described production method, according to another embodiment, provides excellent shape control in accordance with a crystalline form corresponding to a composition of the titanium oxide particles that are to be produced. With the controlled crystalline form, the titanium oxide particles of this embodiment can have a euhedral shape, such as a polyhedral shape or a generally spherical shape. The shape may be a polyhedral shape that has flat surfaces and is substantially similar to a spherical shape or may be a generally spherical shape that has a smooth spherical surface. Titanium oxide particles having such a shape can be produced with the later-described production method.

The titanium oxide particles of this embodiment have a low dielectric loss tangent. The titanium oxide particles of this embodiment may have a dielectric loss tangent at 1 GHz of less than or equal to 0.0040, less than or equal to 0.0025, less than or equal to 0.0010, or less than or equal to 0.0008.

The titanium oxide particles of this embodiment may have a relative dielectric constant at 1 GHz of 51 to 160, 53 to 150, or 65 to 120.

The dielectric loss tangent and the relative dielectric constant of the titanium oxide particles of this embodiment are determined as follows. A sample powder is loaded into a measurement tube and placed in a cavity resonator (e.g., CP-001-PW, manufactured by EM labs, Inc.). A complex relative dielectric constant of a mixture of the sample powder and the air is measured at 1 GHz with a vector network analyzer (e.g., P9373A, manufactured by Keysight) under measurement conditions including a temperature of 25° C. Thereafter, the relative dielectric constant (εr) and the dielectric loss tangent (tan δ) of the sample powder are calculated from the measured complex relative dielectric constant, a volume fraction of the sample powder, and the complex relative dielectric constant of air, by using the Lichtenecker logarithmic mixing rule.

The titanium oxide particles of this embodiment are suitable for use as a resin filler that is included in a resin composition. The titanium oxide particles of this embodiment can be used as a dielectric material.

Because of its low dielectric loss tangent, the titanium oxide particles of this embodiment are suitable for use as titanium oxide particles for electronic materials. In this specification, the expression “for electronic materials” means “intended for use in applications in which the titanium oxide particles are included in at least a portion of an electronic device or at least a portion of a component that forms an electronic device”. Preferably, the electronic device is a communication device, and more preferably, a communication device for high-frequency applications.

The titanium oxide particles of this embodiment are suitable for use as a filler for electronic materials that is included in a composition for forming an electronic device or forming a component of an electronic device. Preferably, the composition is a resin composition. The titanium oxide particles of this embodiment are suitable for use as a filler for electronic materials that is included in a resin composition for forming an electronic device or forming a component of an electronic device.

According to an embodiment of the present invention, a resin composition for electronic materials can be provided. The resin composition for electronic materials includes a resin and titanium oxide particles. The titanium oxide particles contain titanium dioxide, and the titanium dioxide has an average crystallite size of greater than or equal to 220 nm as determined by a peak at 2θ=27.5°±1.0° obtained in an X-ray diffraction measurement.

An example of the titanium oxide particles included in the resin composition for electronic materials is the same titanium oxide particles as those described as examples in the above-described embodiment.

The resin included in the resin composition for electronic materials is not particularly limited. Examples of the resin include thermosetting resins and thermoplastic resins.

In this specification, the thermosetting resin is a resin that has a property of being able to become substantially insoluble and infusible when the resin is cured by means such as application of heat or radiation or the use of a catalyst. Specific examples of the thermosetting resin include epoxy resins, phenolic resins, urea resins, melamine resins, benzoguanamine resins, alkyd resins, unsaturated polyester resins, vinyl ester resins, diallyl terephthalate resins, silicone resins, urethane resins, furan resins, ketone resins, xylene resins, thermosetting polyimide resins, benzoxazine resins, active ester resins, aniline resins, cyanate ester resins, styrene maleic anhydride (SMA) resins, and maleimide resins. These thermosetting resins may be used alone or in a combination of two or more.

In this specification, the thermoplastic resin is a resin that can be melt-molded by application of heat. Specific examples of the thermoplastic resin include polyethylene resins, polypropylene resins, polystyrene resins, rubber-modified polystyrene resins, acrylonitrile-butadiene-styrene (ABS) resins, acrylonitrile-styrene (AS) resins, polymethylmethacrylate resins, acrylic resins, polyvinyl chloride resins, polyvinylidene chloride resins, polyethylene terephthalate resins, ethylene vinyl alcohol resins, cellulose acetate resins, ionomer resins, polyacrylonitrile resins, polyamide resins, polyacetal resins, polybutylene terephthalate resins, polylactic acid resins, polyphenylene ether resins, modified polyphenylene ether resins, polycarbonate resins, polysulfone resins, polyphenylene sulfide resins, polyetherimide resins, polyether sulfone resins, polyarylate resins, thermoplastic polyimide resins, polyamide-imide resins, polyetheretherketone resins, polyketone resins, liquid crystal polyester resins, fluororesins, syndiotactic polystyrene resins, and cyclic polyolefin resins. These thermoplastic resins may be used alone or in a combination of two or more.

The resin composition for electronic materials may include one or more additives. Examples of the additives include catalysts, polymerization initiators, inorganic pigments, organic pigments, extender pigments, clay minerals, waxes, surfactants, stabilizing agents, rheology modifiers, coupling agents, dyes, leveling agents, rheology control agents, UV absorbers, antioxidants, flame retardants, plasticizing agents, and reactive diluents.

In the resin composition for electronic materials, it is preferable that a ratio of a content of the titanium oxide particles of this embodiment be 5 to 90 vol % based on a total volume (100 vol %) of the resin composition for electronic materials.

The resin composition for electronic materials can be used, for example, for the production of electronic devices or components for electronic devices that form electronic devices. The resin composition for electronic materials can be used as a molding material and, in addition, for example, as an encapsulating agent, an adhesive, a coating agent, and the like.

According to an embodiment of the present invention, a molded article of the resin composition for electronic materials of the above-described embodiment can be provided. The molded article may be a molded article including the resin composition for electronic materials of the above-described embodiment or may be a molded article made of the resin composition for electronic materials of the above-described embodiment.

Furthermore, according to an embodiment of the present invention, a component for electronic devices that includes the titanium oxide particles of any of the above-described embodiments can be provided. Furthermore, according to an embodiment of the present invention, an electronic device including the titanium oxide particles of any of the above-described embodiments can be provided.

Examples of electronic devices or components for electronic devices that form electronic devices include cables, such as flexible flat cables, antennas, antenna modules, various electronic circuit boards (e.g., printed circuit boards, such as flexible printed circuit boards and built-up printed circuit boards), prepregs, laminates, metal foil-clad laminates, such as copper-clad laminates, resin sheets, insulating members, resin films, adhesive films, fusion films, and semiconductor packages. These electronic devices or components for electronic devices that form electronic devices may include the molded article of the above-described embodiment.

Examples of the communication device include cell phones, smartphones, and IOT devices. These communication devices or components for electronic devices that form communication devices may include the molded article of the above-described embodiment.

The titanium oxide particles of any of the above-described embodiments can be produced, for example, with the method for producing titanium oxide particles described below. Note that the titanium oxide particles of the present invention are not limited to those produced by the method for producing titanium oxide particles according to an embodiment described below.

### [Method for Producing Titanium Oxide Particles]

According to an embodiment, the method for producing titanium oxide particles includes (I) firing a titanium compound in the presence of a molybdenum compound and at least one of a potassium compound or a sodium compound or (II) firing a titanium compound in the presence of a molybdenum compound.

According to this embodiment, the method for producing titanium oxide particles may include a mixing step and a firing step. The mixing step is a step of mixing a titanium compound with a molybdenum compound and at least one of a potassium compound or a sodium compound to form a mixture. The firing step is a step of firing the mixture. Regarding the mixing step, a molar ratio of Mo to M1 of the mixture may be more than 0.5, or greater than or equal to 0.65, greater than or equal to 0.9, or greater than or equal to 1, where M1 represents Na and K.

In the method for producing titanium oxide particles, when the value of the molar ratio (Mo to M1) is more than 0.5, a fluxing effect is improved, and, consequently, the average crystallite size of the titanium dioxide, which is included in the titanium oxide particles that are produced, can be easily improved.

In the mixing step, the molar ratio of Mo to M1 of the mixture may be less than or equal to 3, less than or equal to 2, or less than or equal to 1.5, where M1 represents Na and K.

In the mixing step, the molar ratio of Mo to M1 of the mixture may have a numerical range, which may be, for example, 0.5 over and 3 or less, 0.65 or greater and 3 or less, 0.9 or greater and 2 or less, or 1 or greater and 1.5 or less, where M1 represents Na and K. In instances where the mixture does not contain K, M1 may represent only Na. In instances where the mixture does not contain Na, M1 may represent only K. In instances where the mixture contains both Na and K, M1 may represent a total amount of Na and K.

Regarding amounts of use of the titanium compound and the molybdenum compound, a molar ratio of titanium atoms in the mixture to molybdenum atoms in the molybdenum compound is preferably within a range of 0.5 to 50.0 and more preferably within a range of 0.5 to 35.0 and most preferably within a range of 1.5 to 2θ. Either of these ranges may be selected to produce the titanium oxide particles of any of the above-described embodiments with high efficiency.

If the method for producing titanium oxide particles is (II) as mentioned above, a molar ratio of titanium atoms in the mixture to molybdenum atoms in the molybdenum compound is preferably within 35.0 over and 120.0 or less, and more preferably within 35.0 over and 100.0 or less. When the molar ratio of titanium atoms in the mixture to molybdenum atom in the molybdenum compound is within the above rage, it has excellent crucible separation and easily washing, which is preferred.

The molybdenum compound and the potassium compound may be at least partially replaced with a compound containing molybdenum and potassium, such as potassium molybdate (e.g., K₂MoₙO₃ₙ₊₁, n=1, 2, or 3). Likewise, the molybdenum compound and the sodium compound may be at least partially replaced with a compound containing molybdenum and sodium, such as sodium molybdate (e.g., Na₂MoₙO₃ₙ₊₁, n=1, 2, or 3). In particular, in instances where Na₂Mo₂O₇ or K₂Mo₂O₇ is used, the fluxing effect is increased for the growth of the crystal, and, consequently, the average crystallite size of the titanium dioxide tends to be easily improved. A step of mixing a titanium compound with a compound containing molybdenum and containing at least one of potassium or sodium to form a mixture is also regarded as a step of mixing a titanium compound with a molybdenum compound and at least one of a potassium compound or a sodium compound to form a mixture.

### [Mixing Step]

The mixing step is a step of mixing a titanium compound with a molybdenum compound and at least one of a potassium compound or a sodium compound to form a mixture, or a step of mixing a titanium compound with a molybdenum compound to form a mixture.

The state of mixing in the mixture is not particularly limited and may be any state as long as the molybdenum compound and at least one of the potassium compound or the sodium compound are in the same space that enables the compounds to act on the titanium compound, or the molybdenum compound is in the same space that enables the compounds to act on the titanium compound. Specifically, any of the following states are possible: a state in which the compounds are not mixed with one another; a state resulting from simple mixing of powders; a state resulting from mechanical mixing that uses a mill or the like, a state resulting from mixing that uses a mortar or the like, and other states. The mixing may be carried out in a dry state or in a wet state.

The raw material compounds will be described below.

### [Titanium Compound]

The titanium compound (hereinafter also referred to as a precursor) that is used as a raw material is not particularly limited and may be any compound as long as titanium oxide is formed from the compound by heat treatment. Examples of the titanium compound include titanium chloride, titanium sulfate, metatitanic acid, and titanium oxides, such as amorphous titanium oxide, anatase-type titanium oxide, rutile-type titanium oxide, and anatase and rutile mixed-type titanium oxide. The titanium compound serving as a precursor may have physical properties that are not particularly limited. Examples of the physical properties include shapes, particle sizes, and specific surface areas.

The titanium oxide particles resulting from the firing have a shape that substantially does not reflect the shape of the titanium compound serving as a precursor. Accordingly, a titanium compound having any of a variety of shapes may be suitably used. Examples of the shapes include spherical shapes, amorphous shapes, shapes of a structure having an aspect (e.g., a wire, a fiber, a ribbon, or a tube), and sheet shapes.

Likewise, the titanium oxide particles resulting from the firing have a particle size that substantially does not reflect the particle size of the titanium compound serving as a precursor. Accordingly, a titanium compound having a particle size ranging from several nanometers to several hundred micrometers may be suitably used. In addition, the titanium compound serving as a precursor may have a specific surface area that is not particularly limited. Accordingly, a titanium compound having any of a variety of specific surface areas may be suitably used.

The titanium compound serving as a precursor may be a compound made exclusively of a titanium compound or may contain a small amount of a metal compound. For example, an aluminum compound, a silicon compound, a zinc compound, and/or the like may be present. A content of these metal compounds in the titanium compound serving as a precursor may be less than or equal to 20%, which is preferable in terms of efficiently forming a crystal of titanium oxide with the use of a molybdenum compound as a fluxing agent. More preferably, the content may be less than or equal to 10 mass %.

Furthermore, the titanium compound serving as a precursor may be a composite of a titanium compound and an organic compound. Examples thereof include organic-inorganic composites obtained by modifying titanium oxide with an organosilane; and titanium compound composites including an adsorbed polymer. Any of these composites may also be suitably used. In instances where any of these composites is used, a content percentage of the organic compound is not particularly limited and may be less than or equal to 60 mass %, which is preferable in terms of efficiently producing rutile-type titanium oxide particles having a generally spherical euhedral shape. More preferably, the content percentage may be less than or equal to 30 mass %.

### [Molybdenum Compound]

The firing of the titanium compound in the presence of molybdenum enables the production of titanium oxide particles containing molybdenum. In this process, the molybdenum compound is used as a fluxing agent. The molybdenum compound may be molybdenum oxide or a compound containing acid group anions in which molybdenum metal is bonded to oxygen (the acid group anions are denoted as MOₓⁿ⁻, where M represents a metal, and herein, the metal is molybdenum metal).

The acid group anions (MOₓⁿ⁻) are anions in which molybdenum metal is bonded to oxygen. The compound containing the acid group anions is not particularly limited and may be any compound that is converted to molybdenum oxide at a temperature less than or equal to a firing temperature. Suitable examples of the compound include molybdic acids, H₃PMo₁₂O₄₀, H₃SiMo₁₂O₄₀, and NH₄Mo₇O₁₂. Among these, molybdenum oxide is preferable when cost is of concern. In instances where molybdenum oxide is used, the molybdenum oxide sublimes as the formation of the titanium oxide particles proceeds, and, therefore, most of the molybdenum oxide can be removed from the reaction system.

The compound containing acid group anions (MOₓⁿ⁻) in which molybdenum metal is bonded to oxygen may be a molybdic acid metal salt that is not decomposed at the firing temperature. Suitable examples of the molybdic acid metal salt include sodium molybdate, potassium molybdate, lithium molybdate, and mixtures of two or more molybdic acid metal salts. For example, water-soluble molybdic acid metal salts, such as sodium molybdate, potassium molybdate, and lithium molybdate, are preferable because these salts can be easily removed by washing with water. The fluxing agent may be a mixture of a molybdenum compound and a metal compound. In this instance, the firing is performed at a high temperature to cause a reaction between the molybdenum compound and the metal compound, thereby forming a molybdic acid metal salt. The molybdic acid metal salt that is formed is not particularly limited and may be any molybdic acid metal salt that can serve as a fluxing agent for forming the titanium oxide particles.

For example, compounds containing molybdenum and potassium are suitable as a fluxing agent. Such a compound can be produced, for example, in the process of firing a molybdenum compound and a potassium compound used as raw materials, which are compounds that are less costly and more readily available. In this specification, the instance in which a molybdenum compound and a potassium compound are used as fluxing agents and the instance in which a compound containing molybdenum and potassium is used as a fluxing agent are both regarded as the instance in which a molybdenum compound and a potassium compound are used as fluxing agents, which is an instance referred to as the “presence of a molybdenum compound and a potassium compound”.

For example, compounds containing molybdenum and sodium are suitable as a fluxing agent. Such a compound can be produced, for example, in the process of firing a molybdenum compound and a sodium compound used as raw materials, which are compounds that are less costly and more readily available. In this specification, the instance in which a molybdenum compound and a sodium compound are used as fluxing agents and the instance in which a compound containing molybdenum and sodium is used as a fluxing agent are both regarded as the instance in which a molybdenum compound and a sodium compound are used as fluxing agents, which is an instance referred to as the “presence of a molybdenum compound and a sodium compound”.

Furthermore, the potassium molybdate (K₂MoₙO₃ₙ₊₁, n=1 to 3) contains potassium and, therefore, can have functions of the potassium compound, which will be described below.

Furthermore, the sodium molybdate (Na₂MoₙO₃ₙ₊₁, n=1 to 3) contains sodium and, therefore, can have functions of the sodium compound, which will be described below.

The fluxing agent containing a molybdenum compound may be a compound made exclusively of a molybdenum compound or may contain one or more other inorganic compounds. For example, the fluxing agent may contain a calcium compound, an iron compound, a silicon compound, and/or the like. A content of the one or more other inorganic compounds may be less than or equal to 20% on an oxide basis. Such a content is preferable in terms of efficiently forming rutile-type titanium oxide particles with the use of a molybdenum compound as a fluxing agent. More preferably, the content may be less than or equal to 10 mass.

Furthermore, the fluxing agent containing a molybdenum compound may be a composite of a molybdenum compound and an organic compound. Examples thereof include organic-inorganic composites obtained by modifying a molybdenum compound with an organosilane; and molybdenum compound composites including an adsorbed polymer. Any of these composites may also be suitably used. In instances where any of these composites is used, a content percentage of the organic compound is not particularly limited and may be less than or equal to 60 mass %, which is preferable in terms of efficiently producing rutile-type titanium oxide particles. More preferably, the content percentage may be less than or equal to 30 mass %.

The molybdenum compounds described above may be used alone or in a combination of two or more.

### [Potassium Compound]

Examples of the potassium compound include, but are not limited to, potassium chloride, potassium chlorite, potassium chlorate, potassium sulfate, potassium hydrogen sulfate, potassium sulfite, potassium bisulfite, potassium nitrate, potassium carbonate, potassium hydrogen carbonate, potassium acetate, potassium oxide, potassium bromide, potassium bromate, potassium hydroxide, potassium silicate, potassium phosphate, potassium hydrogen phosphate, potassium sulfide, potassium hydrogen sulfide, potassium molybdate, and potassium tungstate. Examples of the potassium compound include isomers, as in the instance of the molybdenum compound. Among these, potassium carbonate, potassium hydrogen carbonate, potassium oxide, potassium hydroxide, potassium chloride, potassium sulfate, and potassium molybdate are preferable. Potassium carbonate, potassium hydrogen carbonate, potassium chloride, potassium sulfate, and potassium molybdate are more preferable.

The potassium compounds mentioned above may be used alone or in a combination of two or more.

Furthermore, as described above, since the potassium molybdate contains molybdenum, the potassium molybdate can have functions of the molybdenum compound described above.

### [Sodium Compound]

Examples of the sodium compound include, but are not limited to, sodium carbonate, sodium molybdate, sodium oxide, sodium sulfate, sodium hydroxide, sodium nitrate, sodium chloride, and metallic sodium. Among these, sodium carbonate, sodium molybdate, sodium oxide, and sodium sulfate are preferable in terms of industrially easy availability and ease of handling.

The sodium compounds mentioned above may be used alone or in a combination of two or more.

Furthermore, as described above, since the sodium molybdate contains molybdenum, the sodium molybdate can have functions of the molybdenum compound described above.

Thus, some of the compounds are redundantly referred to as a molybdenum compound because of the classifications. It is preferable that the above-described molybdenum compound be at least one compound selected from the group consisting of molybdenum oxide, potassium molybdate, and sodium molybdate, that the above-described sodium compound be sodium carbonate or sodium molybdate, and that the above-described potassium compound be potassium carbonate or potassium molybdate.

It is more preferable that the mixing step be a step of mixing a titanium compound with a compound containing molybdenum and potassium or with a compound containing molybdenum and sodium, to form a mixture, that the compound containing molybdenum and potassium be K₂Mo₂O₇, and that the compound containing molybdenum and sodium be Na₂Mo₂O₇.

### [Firing Step]

The firing step is a step of firing the mixture. Regarding the firing, when the firing temperature is greater than 700° C., the molybdenum compound functions as a fluxing agent and, therefore, efficiently acts for the formation of titanium oxide particles having a degree of rutile crystallinity of greater than or equal to 90%.

The temperature for the firing may be any temperature greater than or equal to a temperature at which desired titanium oxide particles are formed. Specifically, a maximum temperature may be any temperature within a range of 700 to 1400° C. In particular, in terms of efficiently forming the titanium oxide particles in which titanium dioxide has an average crystallite size of greater than or equal to 220 nm as determined by a peak at 20=27.5°±1.0° obtained in an X-ray diffraction measurement, it is more preferable that the firing be performed at a firing temperature of 800 to 1400° C. It is even more preferable that the firing be performed at a firing temperature of 800 to 1350° C., and it is most preferable that the firing be performed at a firing temperature of 1200 to 1350° C.

If the method for producing titanium oxide particles is (II), the firing temperature is preferably within the range 800 to 1400° C., more preferably within the range 800 to 1350° C., most preferably within the range 900 to 1100° C.

Regarding a firing time, it is preferable that heating for increasing a temperature to a predetermined firing temperature be performed for 20 minutes to 10 hours and that the firing at the firing temperature be performed for 5 minutes to 45 hours with the firing temperature being held.

If the method for producing titanium oxide particles is (II), the heating for increasing a temperature to a predetermined firing temperature be performed for 20 minutes to 10 hours and the holding time associated with the firing temperature is preferably within the range of 5 minutes to 45 hours, more preferably within the range of 15 minutes to 20 hours, most preferably within the range of 2 to 7 hours.

Preferably, the firing temperature may be 700 to 1400° C., and the holding time associated with the firing temperature may be 5 minutes to 45 hours; more preferably, the firing temperature may be 800 to 1400° C., and the holding time associated with the firing temperature may be 5 minutes to 45 hours; even more preferably, the firing temperature may be 800 to 1350° C., and the holding time associated with the firing temperature may be 10 minutes to 30 hours: and particularly preferably, the firing temperature may be 1200 to 1350° C., and the holding time associated with the firing temperature may be 15 minutes to 30 hours. In instances where any of these conditions are selected, the titanium oxide particles of any of the above-described embodiments can be easily produced.

Atmospheres for the firing are not particularly limited, and, for example, the firing may be performed under an air or oxygen atmosphere or under an inert atmosphere, such as nitrogen or argon. When cost is of concern, an air atmosphere is more preferable.

Apparatuses for performing the firing are not particularly limited, and a so-called firing furnace may be used. It is preferable that the firing furnace be formed of a material that does not react with the sublimed molybdenum oxide, and it is further preferable that a gas-tight firing furnace be used to efficiently utilize the molybdenum oxide.

With the method of this embodiment for producing titanium oxide particles, the titanium oxide particles of any of the above-described embodiments can be produced.

### EXAMPLES

The present invention will now be described in more detail with reference to examples. It should be noted that the present invention is not limited to the examples described below.

### [Analysis and Evaluation]

The measurements described below were performed. Powders of Examples and a Comparative Example were used as samples for the measurements.

### [Average Particle Size]

An image of each of the samples was acquired with a scanning electron microscope (SEM). 50 or more particles were randomly selected from the particles observed in the two-dimensional image, and a maximum length among distances between two points on a contour of a primary particle of each of the 50 or more particles was determined as the particle size. An average of the particle sizes was designated as the average particle size.

### [Analysis of Crystal Phase by X-Ray Diffraction (XRD) Spectroscopy]

The prepared samples were each placed and loaded into a measurement sample holder having a depth of 0.5 mm, in a manner such that the sample was flattened under a given load. The sample holder was placed in a wide-angle X-ray diffractometer (for XRD) (Ultima IV, manufactured by Rigaku Corporation), and a measurement was performed under the following conditions: Cu-Kα radiation; 40 kV and 30 mA; a scanning speed of 2°/minute; and a scanning range of 10 to 70°.

### [Measurement of Median Diameter D₅₀]

A particle size distribution of the sample powders was measured in a dry state with a dry laser-diffraction particle size distribution analyzer (HELOS (H3355) & RODOS, manufactured by Japan Laser Corporation) under conditions including a dispersion pressure of 3 bar and a suction pressure of 90 mbar. A particle diameter at a point at which the distribution curve of a cumulative volume percentage intersected a horizontal axis at 50% was designated as the D₅₀.

### [Composition Analysis by X-Ray Fluorescence (XRF) Spectroscopy]

Approximately 70 mg of each of the prepared samples was placed on filter paper and covered with a PP film and then subjected to a composition analysis, which was performed with an X-ray fluorescence (XRF) spectrometer (PrimusIV, manufactured by Rigaku Corporation). The amounts of the various elements determined by the results of the XRF analysis were calculated as the amounts (mass %) of the corresponding oxides, which are shown in Table 2. Accordingly, the ratios of the contents of the various oxides based on the total mass of each of the samples were calculated.

### [Measurement of Crystallite Size]

The measurement was performed as follows. An X-ray diffractometer (SmartLab, manufactured by Rigaku Corporation) was used. A CALSA was used as a detector, and PDXL2 was used as analysis software. The measurement mode used was the 2θ/θ mode, and the measurement conditions were as described below. From the full width at half maximum of the peak appearing at 2θ=27.5°±1.0°, the average crystallite size of the titanium dioxide was calculated using the Scherrer equation.

### [Measurement Conditions]

Scanning range: 2θ=10 to 70°
Step: 2θ=0.002°
Speed: 2θ=0.05°/minute
βs=20 rpm
Soller/PSC: 2θ=2.5° short
Soller: 2θ=2.5°
Analysis software: PDXL2
System-specific half width: none
Peak shape: automated analysis with a CALSA function

### [Measurement of Relative Dielectric Constant and Dielectric Loss Tangent]

Each of the sample powders was loaded into a measurement tube and placed in a cavity resonator (CP-001-PW, manufactured by EM labs, Inc.). A complex relative dielectric constant of a mixture of the sample powder and the air was measured at 1 GHz with a vector network analyzer (P9373A, manufactured by Keysight) under measurement conditions including a temperature of 25° C. The relative dielectric constant (εr) and the dielectric loss tangent (tan δ) of the sample powder were calculated from the measured complex relative dielectric constant, a volume fraction of the sample powder, and the complex relative dielectric constant of air, by using the Lichtenecker logarithmic mixing rule. Specifically, the calculation was performed as follows. According to the Lichtenecker logarithmic mixing rule, the complex relative dielectric constant of the mixture of the sample powder and the air is defined by equation (1) below.

$$log ε = V 1 log ε1 + V 2 log ε2 \qquad ( 1 )$$

ε is the complex relative dielectric constant of the mixture of the sample powder and the air, ε1 is the complex relative dielectric constant of the sample powder, ε2 is the complex relative dielectric constant of air, V1 is the volume fraction of the sample powder, and V2 is the volume fraction of the air.

Since the complex relative dielectric constant of air is 1, equation (1) can be rewritten as follows.

$$log ε = V 1 log ε1 \qquad ( 2 )$$

The measured value and the volume fraction of the sample powder were substituted into equation (2) to calculate the complex relative dielectric constant of the sample powder. The following relationship holds between the real part (ε′) and the imaginary part (ε″) of the complex relative dielectric constant, the relative dielectric constant (εr), and the dielectric loss tangent (tan δ), and, accordingly, the relative dielectric constant (εr) and the dielectric loss tangent (tan δ) of the sample powder were calculated from the calculated complex relative dielectric constant.

$$ε r = {ε}^{′}$$

$$tan δ = {ε}^{″} / {ε}^{′}$$

[Evaluation of Separability from the Crucible]

The fired product was removed from the crucible, and the proportion of the powder remaining in the crucible walls and bottom was used to evaluate its separability from the crucible. The separability from the crucible was calculated from crucible weight (A), and weight of crucible and powder after firing (B), and weight and powder of crucible after removing the fired product (C). The evaluation was made as follows; if it was less than 9.1, it was marked ┌◯┘, and if it was 0.1 or more, it was marked ┌X┘.

$$separability from the crucible = ( C - A ) / ( B - A )$$

### [Production of Potassium Molybdate]

### Production Example 1

36.17 g of potassium carbonate (K₂CO₃) was mixed with 75.34 g of molybdenum oxide (MoO₃) to form a mixture. The resulting mixture was placed in a crucible and fired in a muffle furnace at 700° C. for 5 hours. Note that the heating was carried out at 5° C./minute. After being cooled to room temperature, the crucible was removed. Accordingly, a powder of Production Example 1 was obtained. An XRD measurement performed on the powder confirmed the synthesis of K₂Mo₂O₇, with a scattering peak corresponding to K₂Mo₂O₇ being observed.

### [Production of Titanium Oxide Particles]

### Example 1

20 g of titanium oxide (TiO₂) and 20 g of the potassium molybdate (K₂Mo₂O₇) produced in Production Example 1, described above, were placed in a 100-mL polypropylene vial and mixed and ground with a paint shaker for 30 minutes to form a mixture. Furthermore, the resulting mixture was homogeneously mixed in a mortar and then placed in a crucible and fired in a muffle furnace at 800° C. for 24 hours. Note that the heating was carried out at 5° C./minute. After being cooled to room temperature, the crucible was removed. Accordingly, a powder was obtained. Subsequently, the powder was dispersed in 80 ml of purified water for 30 minutes, and thereafter, the dispersion was centrifuged at 5000 rpm for 10 minutes to remove the supernatant. This operation was repeated four times. The resulting precipitate was dried at 80° C. for 24 hours and then ground in a mortar to give a powder of Example 1, which was pale yellow.

### Example 2

A powder of Example 2, which was yellow, was obtained by performing an operation similar to that of Example 1. The operation was different from that of Example 1 only in that 24.51 g of metatitanic acid (VK-P101, H₂TiO₃, manufactured by Xuan Cheng Jing Rui New Material Co., Ltd.) was used in place of titanium oxide, and the firing temperature was changed to the temperature shown in Table 1.

### Example 3

A powder of Example 3, which was yellow, was obtained by performing an operation similar to that of Example 1. The operation was different from that of Example 1 only in that the firing temperature was changed to the temperature shown in Table 1.

### Example 4

A powder of Example 4, which was yellow, was obtained by performing an operation similar to that of Example 1. The operation was different from that of Example 1 only in that 110.26 g of metatitanic acid (VK-P101, H₂TiO₃, manufactured by Xuan Cheng Jing Rui New Material Co., Ltd.) was used in place of titanium oxide, 24.7 g of sodium carbonate (Na₂Co₃) and 67.2 g of molybdenum oxide (MoO₃) were used in place of potassium molybdate (K₂Mo₂O₇), and the firing temperature was changed to the temperature shown in Table 1.

### Example 5

A powder of Example 5, which was yellow, was obtained by performing an operation similar to that of Example 4. The operation was different from that of Example 4 only in that 32.2 g of potassium carbonate (K₂Co₃) was used in place of sodium carbonate.

### Reference Example 1

20 g of titanium oxide (TiO₂) and 1 g of molybdenum oxide (MoO₃) were placed in a 100-mL polypropylene vial and mixed and ground with a paint shaker for 30 minutes to form a mixture. Furthermore, the resulting mixture was homogeneously mixed in a mortar and then placed in a crucible and fired in a muffle furnace at 1000° C. for 5 hours. Note that the heating was carried out at 5° C./minute. After being cooled to room temperature, the crucible was removed. Accordingly, a powder was obtained. Subsequently, the powder was dispersed in 80 ml of purified water for 30 minutes, and thereafter, the dispersion was centrifuged at 5000 rpm for 10 minutes to remove the supernatant. This operation was repeated four times. The resulting precipitate was dried at 80° C. for 24 hours and then ground in a mortar to give a powder of Reference Example 1, which was pale yellow.

### Reference Example 2

A powder of Reference Example 2, which was pale yellow, was obtained by performing an operation similar to that of Reference Example 1. The operation was different from that of Reference Example 1 only in that amounts of molybdenum oxide (MoO₃) was change to 0.4 g, and the firing temperature was changed to the temperature shown in Table 1.

### Reference Example 3

A powder of Reference Example 3, which was pale yellow, was obtained by performing an operation similar to that of Reference Example 1. The operation was different from that of Reference Example 1 only in that amounts of molybdenum oxide (MoO₃) was change to 0.6 g, and the firing temperature was changed to the temperature shown in Table 1.

### Comparative Example 1

A powder of Comparative Example 1 was commercially available titanium oxide particles (manufactured by Tayca Corporation).

The synthesis conditions mentioned above are shown in Table 1. The symbol “−” indicates that the compound was not used.

TABLE 1

| | | | | | | | | Firing | Firing |
|---|---|---|---|---|---|---|---|---|---|
| | H₂TiO₃ | TiO₂ | Na₂CO₃ | K₂CO₃ | MoO₃ | K₂Mo₂O₇ | Mo to M1 | temperature | time |
| | g | g | g | g | g | g | Molar ratio | ° C. | h |
| Example 1 | — | 20 | — | — | — | 20 | 1 | 800 | 24 |
| Example 2 | 24.51 | — | — | — | — | 20 | 1 | 1000 | 24 |
| Example 3 | — | 20 | — | — | — | 20 | 1 | 1000 | 24 |
| Example 4 | 110.26 | — | 24.7 | — | 67.2 | — | 1 | 1300 | 24 |
| Example 5 | 110.26 | — | — | 32.2 | 67.2 | — | 1 | 1300 | 24 |
| Reference | — | 20 | — | — | 1 | — | — | 1000 | 5 |
| Example 1 | | | | | | | | | |
| Reference | — | 20 | — | — | 0.4 | — | — | 900 | 5 |
| Example 2 | | | | | | | | | |
| Reference | — | 20 | — | — | 0.6 | — | — | 1100 | 6 |
| Example 3 | | | | | | | | | |

### [Results]

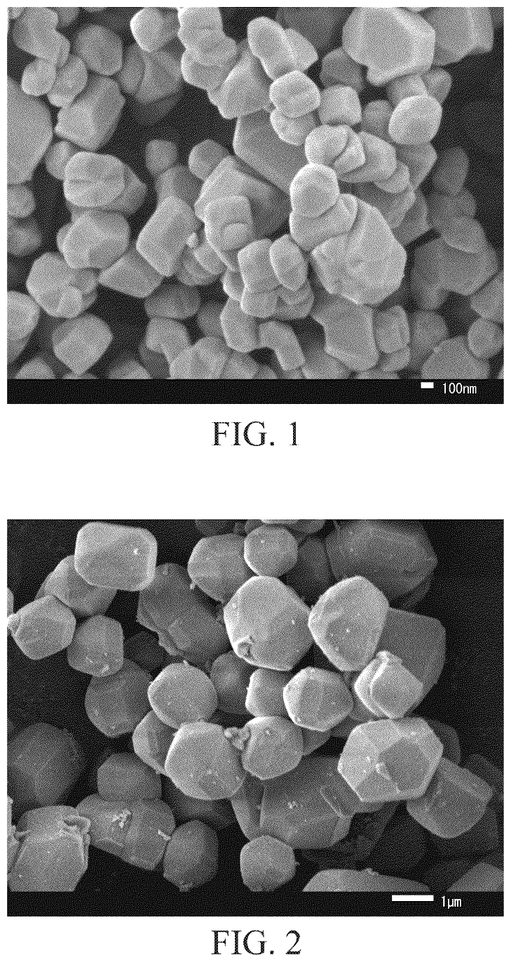

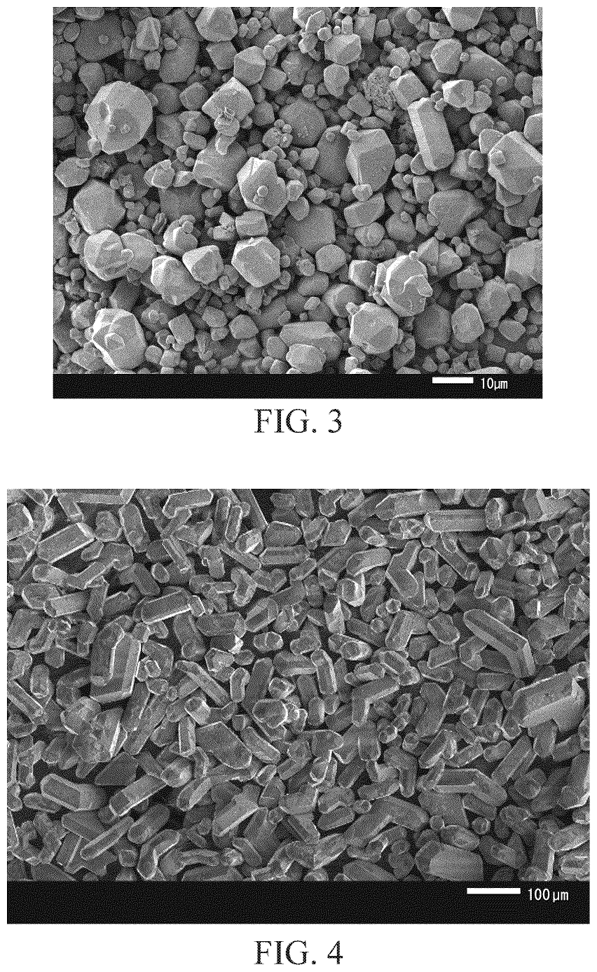

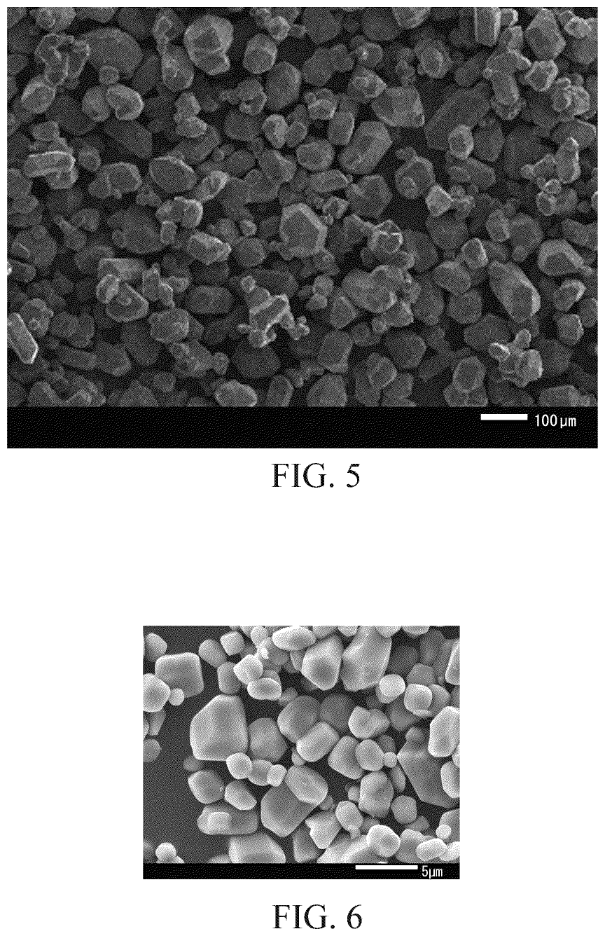

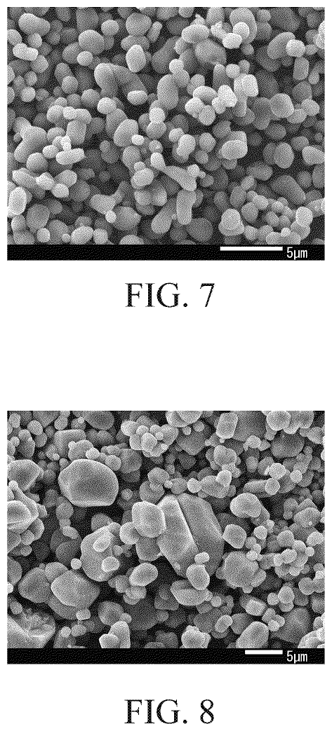

SEM images of the powders obtained in Examples 1 to 5, Reference Examples 1 to 3, described above, are shown in FIGS. 1 to 8.

The results of each of the evaluations, described above, are shown in Table 2. “N. D.” is an abbreviation of “not detected” and indicates an absence of detection.

TABLE 2

| | Average | | | | TiO₂ | | | | |
|---|---|---|---|---|---|---|---|---|---|
| | particle | | | | Average | | Relative | Dielectric | |
| | size | D₅₀ | XRF | | crystallite | | dielectric | loss | Separability |
| | SEM | HELOS | TiO₂ | MoO₃ | size | | constant | tangent | from |
| | μm | μm | mass % | | nm | Shape | εᵣ | tanδ | crucible |
| Example 1 | 0.47 | 0.8 | 98.3 | 1.0 | 225 | Polyhedral | 92 | 0.00191 | X |
| Example 2 | 2.0 | 4.0 | 97.3 | 1.1 | 331 | Polyhedral | 84 | 0.00142 | X |
| Example 3 | 7.0 | 8.5 | 98.4 | 0.6 | 363 | Polyhedral | 56 | 0.000653 | X |
| Example 4 | 100 | 62 | 93.6 | 1.9 | 530 | Polyhedral | 73 | 0.000900 | X |
| Example 5 | 100 | 70 | 94.1 | 1.8 | 510 | Polyhedral | 70 | 0.000911 | X |
| Reference | 3.6 | 4.3 | 98.6 | 0.7 | 255 | Polyhedral | 109 | 0.000780 | ◯ |
| Example 1 | | | | | | | | | |
| Reference | 2.1 | 2.6 | 98.8 | 0.4 | 267 | Polyhedral | 106 | 0.000842 | ◯ |
| Example 2 | | | | | | | | | |
| Reference | 4.9 | 5.5 | 98.3 | 0.7 | 290 | Polyhedral | 97 | 0.000620 | ◯ |
| Example 3 | | | | | | | | | |
| Comparative | 0.74 | 0.2 | 96.9 | N.D. | 214 | Amorphous | 50 | 0.00510 | — |
| Example 1 | | | | | | | | | |

Table 2 shows the shape of the particles of the Examples and the Comparative Example as determined from the SEM images. In instances where it was recognized that particles of different shapes coexisted, a representative shape (the most frequently observed shape) was listed.

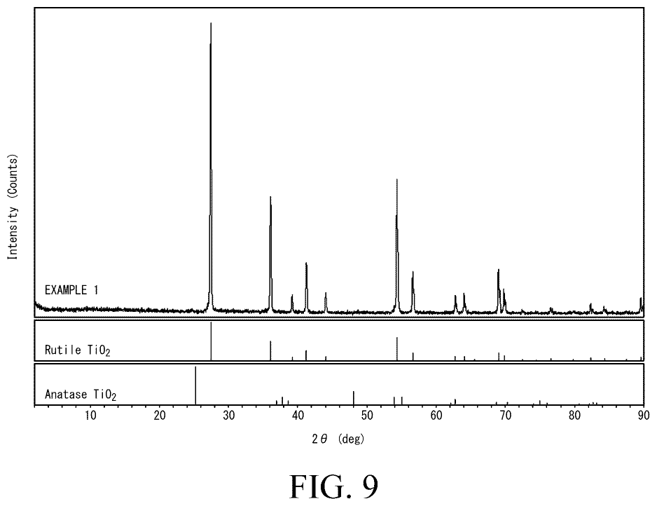

The result of the XRD analysis of the sample of Example 1 is shown in FIG. 9. A sharp scattering peak corresponding to rutile-type titanium dioxide appeared, whereas crystalline peaks other than that of the rutile crystal structure were not observed.

The results of the SEM observation and the XRD analysis confirmed that the particles of the powders obtained in the Examples were titanium oxide particles containing molybdenum and rutile-type titanium dioxide.

The titanium oxide particles of Examples 1 to 5 had a large average crystallite size of titanium dioxide of greater than or equal to 220 nm and, therefore, had lower values of the dielectric loss tangent at 1 GHz than the titanium oxide particles of Comparative Example 1, which indicated an ability to reduce a heat-induced dielectric loss.

The constituents, combinations thereof, and the like in the embodiments are merely illustrative. Addition, omission, and/or substitution of one or more constituents as well as other modifications may be made without departing from the spirit of the present invention. Furthermore, the present invention is not limited to the embodiments and is only limited by the scope of the claims.

1. Titanium oxide particles comprising titanium dioxide, wherein the titanium dioxide has an average crystallite size of greater than or equal to 220 nm as determined by a peak at 2θ=27.5°±1.0° obtained in an X-ray diffraction measurement.

2. The titanium oxide particles according to claim 1, wherein the titanium oxide particles have an average particle size of 0.1 to 300 μm.

3. The titanium oxide particles according to claim 1, wherein the titanium oxide particles contain molybdenum.

4. The titanium oxide particles according to claim 1, wherein the titanium dioxide includes rutile-type titanium dioxide.

5. The titanium oxide particles according to claim 1, wherein the titanium oxide particles have a dielectric loss tangent at 1 GHz of less than or equal to 0.0040.

6. The titanium oxide particles according to claim 1, wherein the titanium oxide particles are intended for use in an electronic material.

7. A resin composition for an electronic material, the resin composition comprising:
a resin; and
the titanium oxide particles according to claim 1.

8. A molded article of the resin composition for an electronic material according to claim 7.

9. A component for an electronic device, the component comprising the titanium oxide particles according to claim 1.

10. A method for producing the titanium oxide particles according to claim 1 comprising:
a mixing step of mixing a titanium compound with a molybdenum compound and at least one of a potassium compound or a sodium compound to form a mixture; and
a firing step of firing the mixture, wherein
a molar ratio of Mo to M1 of the mixture is more than 0.5, where M1 represents Na and K.

11. The method according to claim 10 for producing the titanium oxide particles, wherein
the mixing step is a step of mixing a titanium compound with a compound containing molybdenum and potassium or with a compound containing molybdenum and sodium to form a mixture, and
the compound containing molybdenum and potassium is K₂Mo₂O₇, and the compound containing molybdenum and sodium is Na₂Mo₂O₇.

12. The method according to claim 10 for producing the titanium oxide particles, wherein, in the firing step, the mixture is fired under conditions including a firing temperature of 1200 to 1350° C. and a holding time associated with the firing temperature of 15 minutes to 30 hours.
